(19) United States
(12) Patent Application Publication
(10) Pub. No.: US 2026/0193062 A1
(43) Pub. Date: Jul. 9, 2026

(54) ELEVATOR INSTALLING METHOD

(71) Applicant: Kone Corporation, Helsinki (FI)

(72) Inventors: Matti RÄSÄNEN, Helsinki (FI); Mika IJÄS, Helsinki (FI); Mikko KUKKOLA, Helsinki (FI); Markku HAAPANIEMI, Helsinki (FI)

(73) Assignee: Kone Corporation, Helsinki (FJ)

(21) Appl. No.: 19/555,530

(22) Filed: Mar. 3, 2026

Related U.S. Application Data
(63) Continuation of application No. PCT/EP2023/078795, filed on Oct. 17, 2023.

(51) Int. Cl. B66B 19/00; B66B 19/02

(52) U.S. Cl. CPC B66B 19/005; B66B 19/002; B66B 19/02

(57) ABSTRACT

A method for installing an elevator during construction of a building comprises: providing an elevator car, a counterweight, car guide rails for guiding the car, counterweight guide rails for guiding the counterweight, an elevator hoisting machinery and a suspension roping for suspending the car and the counterweight during construction time use of the elevator; providing a first rope terminal and a second rope terminal for supporting the suspension roping; mounting a car guide rail and two counterweight guide rails on fixing brackets; mounting the counterweight vertically movably on the opposite counterweight guide rails inside said fixing brackets, between said fixing brackets and a wall of a hoistway; providing a motor module comprising a motor bed, the elevator hoisting machinery mounted on the motor bed; vertically moving the car during construction time use by the elevator hoisting machinery suspending the car and the counterweight together with the suspension roping; connecting the guide rails below and above the motor bed to each other through the motor bed; in connection with an elevator jump, hoisting the motor module guided by the counterweight guide rails through one or more fixing brackets to a desired height in the hoistway; and fixing the motor module on said guide rails.

### CROSS-REFERENCE TO RELATED APPLICATION

This application is a continuation of PCT International Application No. PCT/EP2023/078795 which has an International filing date of Oct. 17, 2023, the entire contents of which are incorporated herein by reference.

### FIELD OF THE INVENTION

The invention relates to an elevator installing method during construction of a building.

### BACKGROUND OF THE INVENTION

The construction of an elevator may especially in high-rise buildings be done in parts along the height of the hoistway. The guide rails and the landing doors may first be installed to a first height in the hoistway, then to a second height etc. A construction time elevator may then be operated on the already installed lower portion of the hoistway while the construction of the elevator is going on in a higher portion of the hoistway.

In some cases, the elevator counterweight is positioned behind an elevator car guide rail, with the car guide rail and both counterweight guide rails being attached to a common fixing bracket through which the counterweight can move. The elevator motor is placed on top of the counterweight and is supported by the car guide rail and the two counterweight guide rails.

Making a jump during elevator construction time use CTU has been a challenge in an elevator with the counterweight located behind the car guide rail.

### SUMMARY OF THE INVENTION

An object of the present invention is to present an improved method for installing an elevator during construction of a building.

A particular object of the present invention is to enable elevator installation to be continued above a driving elevator wherein the elevator machinery is mounted on a motor bed fixed on elevator guide rails such as a car guide rail and two counterweight guide rails.

A particular object of the present invention is to allow guide rails to be connected through the motor bed and to allow a motor module to be hoisted through a fixing bracket for the guide rails.

It is also brought forward a new method according to claim 1.

The method for installing an elevator during construction of a building comprises:

providing an elevator car, a counterweight, car guide rails for guiding the car, counterweight guide rails for guiding the counterweight, an elevator hoisting machinery and a suspension roping for suspending the car and the counterweight during construction time use of the elevator,
providing a first rope terminal and a second rope terminal for supporting the suspension roping,
mounting a car guide rail and two counterweight guide rails on fixing brackets,
mounting the counterweight vertically movably on the opposite counterweight guide rails inside said fixing brackets, between said fixing brackets and a wall of a hoistway,
providing a motor module comprising a motor bed, the elevator hoisting machinery mounted on the motor bed,
vertically moving the car during construction time use by the elevator hoisting machinery suspending the car and the counterweight together with the suspension roping,
connecting the guide rails below and above the motor bed to each other through the motor bed,
in connection with an elevator jump, hoisting the motor module guided by the counterweight guide rails through one or more fixing brackets to a desired height in the hoistway, and
fixing the motor module on said guide rails.

According to an embodiment, the method comprises, before the jump, lowering the counterweight to the bottom of the hoistway to a suitable height and slackening ropes or belts of the suspension roping.

According to an embodiment, the method comprises pulling the belts or ropes to the counterweight side of the car and taking them off a drive wheel of the elevator hoisting machinery.

According to an embodiment, the method comprises guiding the motor module comprising guiding and fixing elements, such as guide shoes or guide rollers, in a controlled manner along the counterweight guide rails when hoisted.

According to an embodiment, the method comprises moving the motor module comprising horizontal displacement means enabling horizontal movement of the motor bed relative to the fixing bracket and adapting the motor module inside an open cross section between the fixing bracket and a wall of the hoistway.

According to an embodiment, the method comprises rotating an upwards rotatable front part comprised by the motor module and adapting the motor module to fit inside open cross section between the fixing bracket and a wall of the hoistway.

According to an embodiment, the method comprises hoisting the motor module upwards by a material hoist or equivalent hoisting device operating from upward direction.

According to an embodiment, the method comprises opening an automatic rope lock comprised by the second rope terminal to allow more belt or rope to be transferred into the roping system.

According to an embodiment, the method comprises, before hoisting the car, detaching the first rope terminal on the opposite side of the counterweight from the car guide rail and attaching it to the car.

According to an embodiment, the method comprises performing the upward hoisting by hoisting the motor module to which the second rope terminal is attached at the same time.

According to an embodiment, the hoisting roping comprises plurality of ropes, which are preferably PU-coated.

According to an embodiment, the method comprises, after finishing the final height of the hoistway, the motor bed is fixed on top of the guide rails.

According to an embodiment, the method comprises mounting at least one protection deck within the hoistway having a bottom section, a top section and an optional at least one intermediate section between the bottom and top sections in the building, for an elevator section installation,
providing an installation platform to be guided on car guide rails during installation of at least one hoistway section,
providing a hoist device,
guiding a working platform on car guide rails and the counterweight on counterweight guide rails installed at the bottom of the hoistway,
attaching to the working platform the hoist device comprising a man riding hoist and a hoist rope,
providing a hoisting point to support the working platform via the hoist device and the hoist rope,
mounting the hoisting point to the protection deck for the bottom section elevator installation, and installing elevator components in the bottom section using the working platform as an installation platform,
after each section elevator installation,
during construction time use of the car, using the installation platform as installation platform for an above section installation.

According to an embodiment, the method comprises moving the car during construction time use
after the hoisting point and the hoist device are removed from the bottom section, or
after the hoisting point, the hoist device and the installation platform are removed from the installed hoistway section.

According to an embodiment, the method comprises installing the elevator hoisting machine, supported by the car guide rail at a top of the bottom section, and installing the suspension roping to suspend the car and the counterweight, and moving the car during construction time use in the bottom section, after the hoist device, or after the hoist device and the installation platform, is removed from the bottom section.

According to an embodiment, the method comprises, during the elevator installation in the at least one intermediate section, mounting the hoisting point to an upper protection deck, attaching to the installation platform the hoist device and the hoist rope, and using the installation platform as installation platform.

According to an embodiment, the method comprises, after the intermediate section installation, installing the elevator hoisting machinery, supported by the car guide rail at a top of the intermediate section, and installing an extended suspension roping to suspend the car and the counterweight, and moving the car during construction time use in the intermediate section, after the hoist device and the installation platform are removed from the intermediate section.

According to an embodiment, the method comprises, during the elevator installation in the top section, moving the hoisting point to a ceiling of the hoistway.

According to an embodiment, the method comprises hoisting the motor module by a material hoist supported by the protection deck.

According to an embodiment, the method comprises hoisting car guide rails and counterweight guide rails and other heavy elevator components by the material hoist.

According to an embodiment, the method comprises hoisting guide rails and other heavy elevator components by the car and/or the installation platform.

According to an embodiment an elevator construction arrangement comprises:
a hoistway;
an elevator car, a counterweight, car guide rails for guiding the car, counterweight guide rails for guiding the counterweight;
an elevator hoisting machinery and a suspension roping arranged to suspend the elevator car and the counterweight during construction time use of the elevator;
a first rope terminal and a second rope terminal for supporting the suspension roping;
a motor module comprising a motor bed, the elevator hoisting machinery mounted on the motor bed; wherein
during construction time use of the elevator, the motor module is mounted on a fixing bracket supporting a plurality of said guide rails;
said plurality of guide rails are adapted to pass through the motor bed; and
the motor module is hoistable through one or more fixing brackets in connection with an elevator jump.

According to an embodiment, the motor module comprises fixing and guiding elements, such as guide shoes or guide rollers, to guide the motor module in a controlled manner along the counterweight guide rails when hoisted.

According to an embodiment, the motor module comprises horizontal displacement means enabling horizontal movement of the motor bed relative to the fixing bracket and adapting the motor module to fit inside open cross section between the fixing bracket and a wall of the hoistway.

According to an embodiment, the motor module comprises an upwards rotatable front part enabling adapting the motor module to fit inside open cross section between the fixing bracket and a wall of the hoistway, and preferably the rotational displacement of the front part is provided by means of a hinge.

According to an embodiment, the guide rails below and above the motor bed are adapted to be connected to each other through the motor bed when the elevator is driving below the motor module.

According to an embodiment, wherein a material hoist or equivalent hoisting device operating from upward direction is configured to hoist the motor module upwards in connection with the elevator jump.

According to an embodiment, the hoisting roping comprises plurality of ropes, which are preferably PU-coated.

According to an embodiment, the hoisting roping comprises PU-coated round ropes or PU-coated belts.

According to an embodiment, the motor module comprises the second rope terminal, which is preferably supported by the motor bed.

According to an embodiment, the second rope terminal is arranged to act together with a suspension roping suspension wheel, which is preferably supported by the motor bed.

According to an embodiment, the second rope terminal comprises an automatic rope lock device allowing opening and locking the second rope terminal to feed more belt or rope through the second rope terminal.

According to an embodiment, the automatic rope lock device is adapted to keep all ropes of the suspension roping the same length and at a constant tension.

According to an embodiment, downwards from the second rope terminal the suspension roping is arranged to pass to suspension roping reels, preferably located at a building floor or at the bottom of the hoistway.

According to an embodiment, after finishing the final height of the hoistway, the motor bed is adapted to be mounted above the guide rails.

The simple and safe solution allows to reduce the masses to be hoisted and enables a fast jump. The solution allows the jump use of elevators also with fixing brackets as described in this description. The solution allows the use of PU ropes and PU belts. The fixing brackets do not get in the way when moving components upwards.

### BRIEF DESCRIPTION OF THE DRAWINGS

The invention will in the following be described in greater detail by means of preferred embodiments with reference to the attached drawings, in which:

FIGS. 1 and 2 show details of an elevator construction arrangement, in which an elevator machinery is mounted on a motor bed fixed on elevator guide rails such as a car guide rail and two counterweight guide rails,

FIGS. 3 and 4 show details of an elevator construction arrangement, in which guide rails pass through the motor bed and allow a motor module to be hoisted through a fixing bracket for the guide rails,

FIGS. 5 and 6 show an elevator motor bed fixed on top of a car guide rail and two counterweight guide rails,

FIGS. 7-11 show various installation phases of the elevator, and

FIGS. 12 and 13 show details of an elevator construction arrangement, in which guide rails pass through the motor bed and allow a motor module to be hoisted through a fixing bracket for the guide rails.

### DETAILED DESCRIPTION

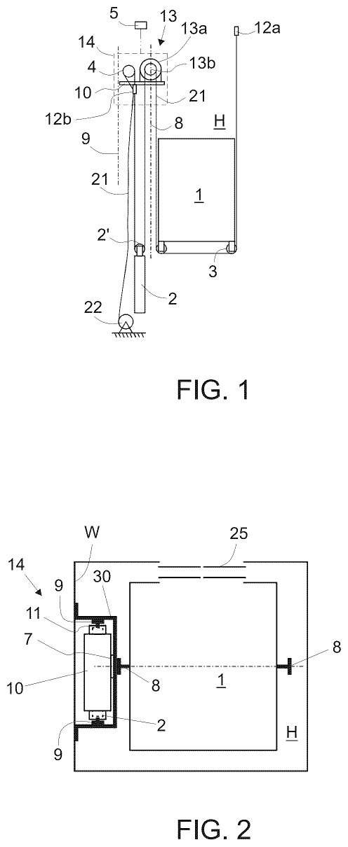

FIGS. 1 and 2 show an elevator in an elevator construction arrangement with an elevator car 1 and a counterweight 2 arranged vertically movable in a hoistway H. The elevator car 1 and the counterweight 2 are suspended with a hoisting roping 21 passing around a drive wheel 13b of an elevator hoisting machinery 13.

The machinery 13 is mounted on a motor bed 10 fixed on elevator guide rails such as one car guide rail 8 and two counterweight guide rails 9. The car guide rail 8 and the two counterweight guide rails 9 are mounted on fixing brackets 30 shown in FIG. 2 supporting said guide rails 8, 9. Fixing brackets 30 are attached to a wall W of the hoistway H.

The counterweight guide rails 9 are mounted opposite each other inside the fixing bracket 30, and one car guide rail 8 is mounted on the outer side of the fixing bracket 30.

The motor bed 10 comprises guiding and fixing elements 11 by means of which the motor bed 10 is vertically fixed and releasably attached to two counterweight guide rails 9.

According to an embodiment the guiding and fixing elements 11 such as guide shoes or guide rollers guide the motor bed 10 in a controlled manner along the counterweight guide rails 9 when hoisted.

According to an embodiment, the motor bed 10 further comprises a fixing element 7 by means of which the motor bed 10 is vertically fixed to the car guide rail 8 during construction time use of the elevator.

According to an embodiment, for a hoisting operation in connection with an elevator jump, the guiding and fixing elements 11 are released from the counterweight guide rails 9, the fixing element 7 is detached from the car guide rail 8, and thereafter the motor bed 10 is hoisted upwards guided by the counterweight guide rails 9.

FIGS. 1 and 8 illustrate preferred details of how the roping 21 passes. The roping 21 is arranged to pass from a first rope terminal 12a downwards to the elevator car 1, around one or more rope wheels 3 of the car 1, upwards to a motor module 14 comprising the machinery 13, around the drive wheel 13b thereof, downwards to the counterweight 2, around one or more rope wheels 2′ of the counterweight 2, upwards to a second rope terminal 12b.

According to an embodiment the second rope terminal 12b is used at least temporarily during the elevator construction and may be replaced by a final second rope terminal for the elevator final use.

According to an embodiment the second rope terminal 12b is arranged to act together with a suspension roping suspension wheel 4.

According to an embodiment the hoisting roping 21 is arranged to pass from the second rope terminal 12b upwards to said suspension wheel 4, around the suspension wheel, and back to the second rope terminal 12b.

According to an embodiment, downwards from the second rope terminal 12b the roping 21 is arranged to pass to suspension roping reels 22.

According to an embodiment the second rope terminal 12b comprises an automatic rope lock device allowing opening and locking the second rope terminal 12b to feed more belt or rope through the second rope terminal 12b when the driving height of the construction time construction time use CTU elevator is to be extended. According to an embodiment wedges of the second rope terminal 12b are opened and locked in the feeding process of belt or rope through the second rope terminal 12b.

During the jump, the rope wedges of the automatic rope lock device are opened and the ropes are allowed to run through the automatic rope lock device while the machinery 13 and the motor bed 10 are lifted upwards. The excess ropes 21 run inside the fixing brackets 30 between the counterweight and the wall to rope reels 22. Once the machinery and the automatic rope lock device have been raised to the next position, the rope wedges are locked and the car and first rope terminal 12a are moved to the final position.

According to an embodiment the automatic rope lock device is adapted to keep all ropes of the suspension roping 21 the same length and at a constant tension.

When the automatic rope lock device is hoisted at the same time as the machinery 13, it is easy to control the automatic lock during hoisting, only the required amount of ropes is increased in the system during hoisting, and a faster jump time is achieved.

During the jumping and hoisting process, all ropes can remain the same length and at a constant tension, which is very important for urethane-coated ropes.

According to an embodiment belt or rope reels 22 for the extendable hoisting roping 21 are located at a building floor or at the bottom of the hoistway H.

The motor module 14 comprising the motor bed 10 and the elevator hoisting machinery 13 mounted on the motor bed 10, forming preferably an integral hoistable unit, is hoistable through the fixing bracket 30.

According to an embodiment the motor module 14 comprises the second rope terminal 12b.

According to an embodiment the motor module 14 comprises the hoisting roping suspension wheel 4.

According to an embodiment the machinery 13, the suspension wheel 4 and the second rope terminal 12b are supported by the motor bed 10.

The motor module 14 is attached to the guide rails 8, 9 during construction time use of the elevator. According to an embodiment the motor module 14 is also attached to the hoistway wall.

According to an embodiment the motor module 14 comprises guiding and fixing elements 11 such as guide shoes or guide rollers to guide the motor module 14 in a controlled manner along the counterweight guide rails 9 when hoisted.

According to an embodiment a material hoist 5 or equivalent hoisting device operating from upward direction is used for hoisting the motor module 14 upwards in connection with an elevator jump.

The hoisting roping 21 preferably comprises plurality of ropes, which are preferably belt shaped.

According to an embodiment the ropes are PU-coated, preferably PU-coated round ropes or PU-coated belts having significantly better friction properties than conventional steel ropes without polyurethane coating.

Belts can only be bent in one direction, so the counterweight 2 is located on the side of the car 1, behind the car guide rail 8, preferably centrally, in the machine room less elevator solutions shown in the Figures.

The elevator car 1 is arranged to be vertically movable in the hoistway H along the car guide rail lines 8, and the counterweight 2 is arranged to be vertically movable in the hoistway H along the counterweight guide rail lines 9.

The machinery 13 for driving the hoisting roping 21 comprises a motor 13a and a drive wheel 13b, wherein the motor 13a is preferably an electric motor. The motor bed 10 comprises a horizontal beam.

FIGS. 1-4 show details of an elevator construction arrangement, in which guide rails 8, 9 pass through the motor bed 10 and allow it to be hoisted through the fixing bracket 30 for the guide rails 8, 9.

In the elevator construction arrangement, the motor bed 10 is configured in such a way that the guide rails can be connected through the motor bed.

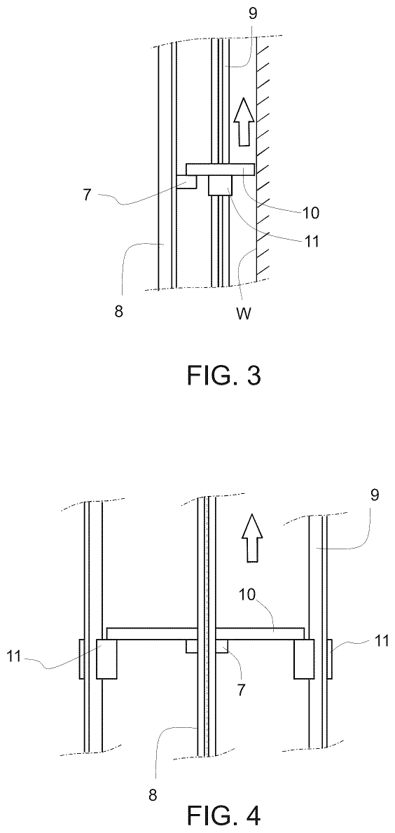

FIGS. 3 and 4 show two side views, perpendicular with respect to each other, of the motor bed 10 illustrated in FIGS. 1 and 2, hoistable upwards supported on counterweight guide rails 9.

The motor bed 10 solutions shown in FIGS. 1-4 can be used for an elevator jump above the driving elevator. The guide rails 8, 9 can be passed through the motor bed 10. The motor bed 10/motor module 14 can be hoisted inside the guide rail fixing bracket 30.

The guide rails below and above the motor bed 10 can be connected to each other through the motor bed when the elevator is driving below the motor bed 10/motor module 14.

According to an embodiment, after finishing the final height of the hoistway H, the motor bed 10 is arranged above the guide rails 8,9. This facilitates a reliable and simple ability to carry via the motor bed a big weight. Hereby, for example harmfully big torques in mechanical connections between parts can be avoided.

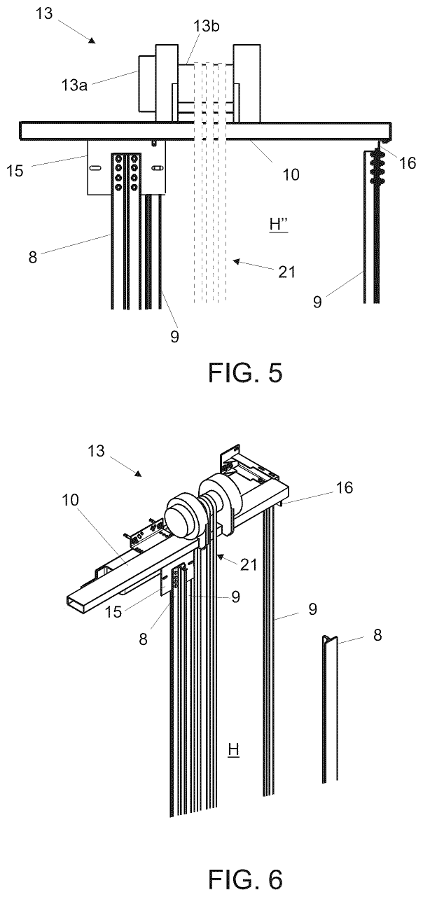

FIGS. 5 and 6 show principle of an elevator where the machinery 13 is mounted on the motor bed 10 fixed on top a car guide rail 8 and two counterweight guide rails 9 in an uppermost location of the hoistway H.

In FIGS. 5 and 6, the motor bed 10 is fixed to the upper ends of the guide rail sections 8, 9. In the embodiment illustrated, the motor bed 10 is fixed to the upper end of each of the guide rail sections 8, 9 by a fixing bracket 15; 16. This is more particularly implemented such that the upper end of each of the guide rail sections 8, 9 is immovably fixed to a fixing bracket 15, 16 immovably fixed to the motor bed 10. Providing support for the motor bed 10 by the car guide rail 8 and two counterweight guide rails 9 provides a substantially stable support and reduces weight to be carried per guide rail section. Implementing this by mounting the machinery 13 on the motor bed 10 mounted on said guide rails 8, 9 provides that the advantages related to stability and bearing abilities of the guide rails are achieved with relatively good freedom to position the machinery.

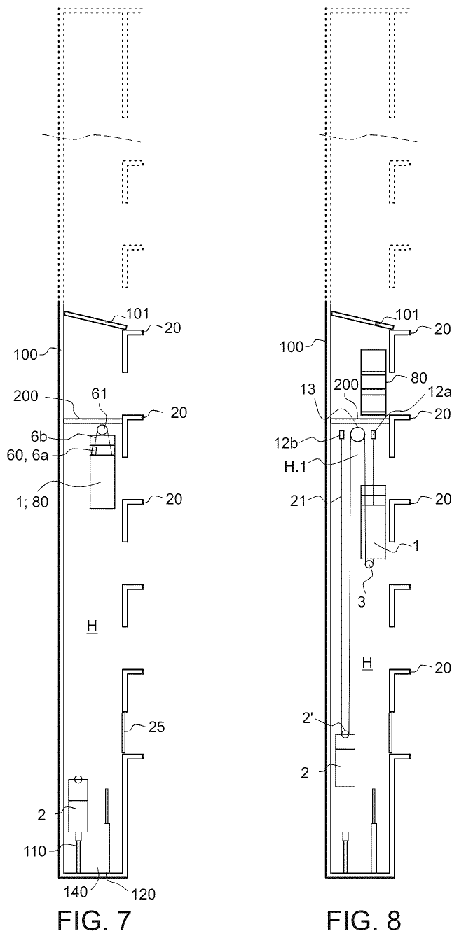

In order to describe the CTU elevator installation during construction of a building 100, wherein the machinery 13 is mounted on the motor bed 10 fixed on elevator guide rails such as the car guide rail 8 and two counterweight guide rails 9, various installation phases are illustrated in FIGS. 7-11.

A weather deck 101 and a temporary working deck may be installed in the elevator hoistway H preferably by the builder. The weather deck 101 may be an inclined waterproof deck which seals the hoistway to keep it clean and dry.

The elevator installers may install a protection deck 200 from the working deck for protecting the portion of the hoistway below the protection deck 200 from any possible falling objects.

The protection deck may comprise a lifting point to be used for hanging a material hoist 5 illustrated in FIG. 1 or equivalent hoisting device such as a chain hoist which may be used for elevator hoisting machinery 13/motor bed 10/motor module 14 hoisting.

When more height is needed in connection of a jump, the counterweight 2 is lowered to the bottom of the hoistway H to a suitable height (FIG. 1) and the ropes or belts 21 are slackened.

According to an embodiment, preferably using pulling cords, the belts or ropes 21 are pulled to the counterweight side of the car 1 and taken off the drive wheel 13b.

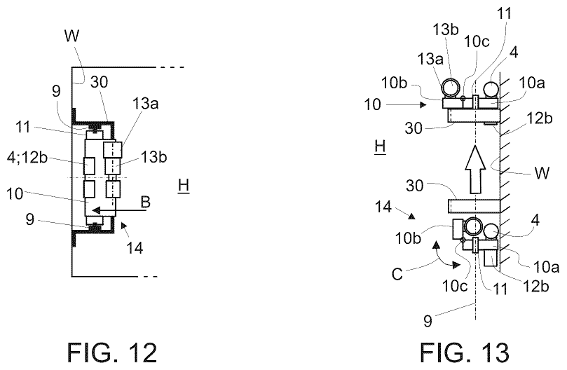

According to an embodiment, the machinery 13 is moved by either sliding or rotating the motor bed 10 away from the fixing bracket 30. It is then possible to hoist the machinery inside the fixing bracket 30 as described along FIGS. 12 and 13. According to an embodiment, the machinery is detached from the motor bed 10 and moved upwards on the roof of the car.

According to an embodiment, before hoisting with the material hoist 5, possible fixing bolts of the motor module 14 are detached from the guide rails 8, 9, and the wall, if applicable.

According to an embodiment, the automatic rope lock 12b is opened to allow more belt or rope to be transferred into the system. The extra belt or rope is stored, for example, at the bottom of the hoistway.

According to an embodiment, also the first rope terminal 12a on the opposite side of the counterweight is detached from the car guide rail 8 and attached to the car 1.

According to an embodiment, performing the upward hoisting by hoisting the motor module 14 to which the second rope terminal 12b (automatic rope lock) is attached at the same time. Hoisting the module 14 is safe because the guiding and fixing elements 11 guide it along the counterweight guide rails 9.

Thereafter, the motor module 12, rope terminals and other components are attached at the desired height.

The arrangement comprises a hoist device 60 which serves for hoisting an elevator car 1 or an installation platform 80.

The hoist device 60 comprises a first hoisting machine 6a also called a man riding hoist 6a and a first flexible tension member 6b also called a hoist rope 6b movable with the first hoisting machine 6a.

The arrangement comprises a hoisting point configured to support the car 1 or the installation platform 80 via the first hoisting machine 6a and the first flexible tension member 6b.

In FIG. 7, a rotatable diverting pulley 61 is supported by the protection deck 200 for guiding and supporting the hoist rope 6b.

The protection deck 200 with auxiliary equipment may be used as movable installation tool for hoisting of large loads such as: a movable machine room of an elevator located below the protection deck or, as shown e.g. in FIG. 7, an elevator car 1 or an installation platform 80 below the protection deck, and construction material 8, 9.

In FIG. 7, the hoisting machine 6a is mounted separate from the protection deck 200. The hoisting machine 6a may be mounted on the elevator car 1 or the installation platform 80 and the first flexible tension member 6b passes around the diverting pulley 61.

The material hoist 5 may be used to hoist car guide rails 8 and counterweight guide rails 9 and other heavy elevator components during the installation of the elevator.

Once the protection deck is installed and the hoistway is sealed, the elevator installation can start for the bottom section of the hoistway below the protection deck.

In the bottom section of the hoistway below the protection deck, car guide rails 8, counterweight guide rails 9, a counterweight buffer assembly 110, a car buffer assembly 120, a counterweight 2 and a working platform are installed in a pit 140. The working platform 1, 80 is then used as the installation platform for the bottom section of the hoistway. The working platform comprises the car 1 or the installation platform 80.

According to an embodiment by the car 1 is meant at least parts of the car, such as a car sling, which may be guided on the car guide rails 8. According to an embodiment the working platform comprises the car with the car sling which is complemented by a platform such as a working deck for the installer. According to an embodiment the working platform comprises the car with the sling but does not have walls and a roof. According to an embodiment the car is equipped also with walls and a roof. According to an embodiment the car is a final car. According to an embodiment, the working platform comprises the car 1 or at least parts of the car to be guided on the car guide rails. According to an embodiment, the working platform comprises the installation platform 80.

According to an embodiment the car 1 is used as the working platform in the bottom section. The car is moved with the help of the hoist device 60 such as the man riding hoist 6a. The landing doors 25 and other elevator hoistway components are installed in the bottom section of the hoistway. The elevator installation below the protection deck is then completed for construction time use. An elevator hoisting machine 13 and elevator suspension ropes 21 are installed and a temporary headroom H.1 electrification is finalized in the uppermost part of the bottom section of the hoistway H below the protection deck. Thereafter the elevator is inspected and handed over for construction time use to serve the bottom section of the hoistway (FIG. 8).

While the elevator is installed at the bottom section of the building 100, the building construction continues normally above it.

FIG. 8 shows the CTU elevator in the bottom section and an installation platform 80 moved on top of the protection deck 200 as a preparation for a next section elevator installation.

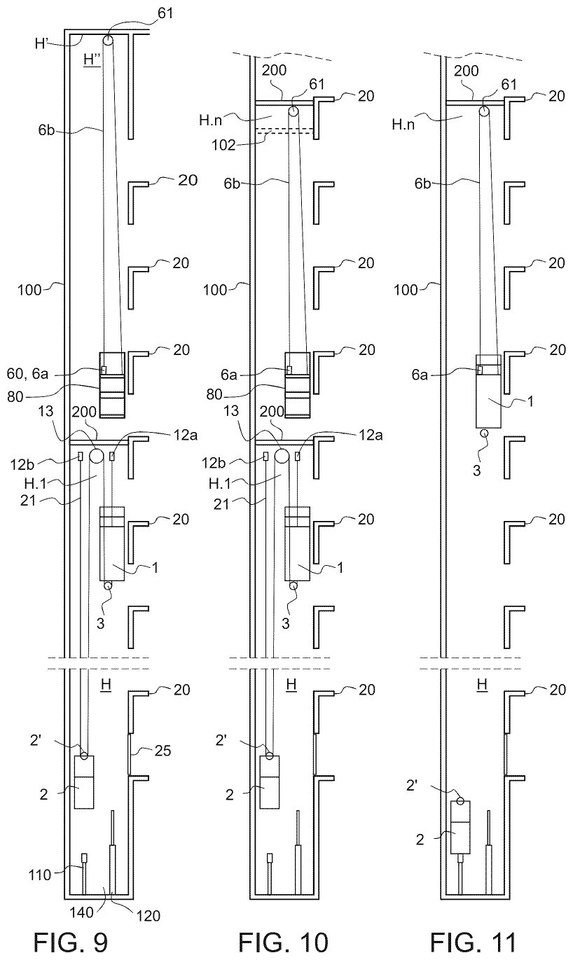

The installation platform 80 supported by the protection deck (FIG. 10) or the ceiling H′ (FIG. 9) of the hoistway may be used in the next at least one installation above the bottom section. The elevator installation is paused until the hoistway for a next section is ready.

When the next section above the bottom section is a top section as shown in FIG. 9, the hoist device 60 is connected to the ceiling H′ of the hoistway for supporting the installation platform 80.

When the next section above the bottom section is an intermediate section in case the elevator is installed in more than two sections as shown in FIG. 10, the hoist device 60 such as the man riding hoist 6a is supported utilizing a second protection deck 200. The elevator installation with guide rails, landing doors, elevator hoistway electrification etc. continues for the next section from the installation platform 80.

Guide rails 8, 9 are passed through the motor bed 10 and allow the motor bed 10/motor module 14 to be hoisted through fixing brackets 30 for the guide rails.

For jumping, in other words extending the travel to the next intermediate section, the elevator is taken out of CTU in the below section and the below section top components are moved to the temporary headroom H.n of the now finalized intermediate section.

The motor bed 10 with equipment attached to it forming the motor module 14 is jumped through fixing brackets 30 to the next jump level.

The suspension ropes 21 are extended or replaced with longer ones. The installation platform 80 and the below protection deck 2 are taken out of the hoistway H. The elevator is inspected and handed over for construction time use, while the elevator installation above continues in case of a multi-zone elevator installation. The intermediate section installation is repeated as many times as needed.

In short, for the top section installation the installation platform 80 is supported from the ceiling H′ as shown in FIG. 9. The elevator installation with guide rails, landing doors, elevator hoistway electrification etc. continues for the top section from the installation platform 80. For extending the travel up to the top section, the elevator in the below section is taken out of CTU and the below section top components are moved to the final headroom H″ of the installed top section. The motor bed 10 is fixed on top of a car guide rail 8 and two counterweight guide rails 9 as exemplified along FIGS. 5 and 6.

A final electrification is installed to the headroom H″. The suspension ropes 21 are extended during the jump or replaced with longer ones. The installation platform 80 and respective below protection deck are taken out of the hoistway. The elevator is inspected and handed over for construction time use for the full height of the building as shown in FIGS. 9 and 10. The elevator runs in construction time use for whole travel until the final handover. The car 1 may transport people and/or goods between the landings 20 in the building 100.

FIGS. 12 and 13 show details of an elevator construction arrangement, in which guide rails 8, 9 pass through the motor bed 10 and allow the motor module 14 to be hoisted through the fixing bracket 30 for the guide rails 8, 9. In the elevator construction arrangement, the motor bed 10 is configured in such a way that the guide rails can be connected through the motor bed.

When the elevator is in construction time use, the drive wheel 13b may be placed on top of a common fixing bracket 30 for the guide rails 8, 9.

According to an embodiment the motor module 14 comprises horizontal displacement means B enabling horizontal movement of the motor bed 10 relative to the fixing bracket 30. The horizontal displacement means enable adapting the motor module to fit inside an open cross section between the fixing bracket 30 and a wall of the hoistway H.

As preparation for hoisting, according to the embodiment shown in the top view of FIG. 12, the motor bed 10 of the motor module 14 with the machinery 13 is moved in relation to the fixing bracket 30 and the guiding and fixing elements 11, horizontally inwards B inside the fixing bracket 30, in other words, inside the open cross section between the fixing bracket 30 and a wall W of the hoistway H. Thereafter the motor module 14 is hoisted in a controlled manner upwards supported by guiding and fixing elements 11 guided by the counterweight guide rails 9.

According to an embodiment the motor module 14 comprises an upwards rotatable part 10b enabling adapting the motor module 14 to fit inside the open cross section between the fixing bracket 30 and a wall W of the hoistway H.

As preparation for hoisting, according to the embodiment shown in the side view of FIG. 13, a part of the motor module 14 comprising a front part 10b of the motor bed 10 with the motor 13a and the drive wheel 13b is rotated upwards C inside the open cross section between the fixing bracket 30 and a wall W of the hoistway H. According to an embodiment the front part 10b of the motor bed 10 is rotated to an upward position relative to a rear part 10a of the motor bed 10 by means of a hinge 10c.

According to an embodiment, the solutions described with FIGS. 12 and 13 can also be combined, so that the motor module 14, guided along the counterweight guide rails 9, can be hoisted through the fixing bracket 30. According to an embodiment the motor module 14 comprises horizontally movable means B enabling horizontal movement of the motor bed 10 relative to the fixing bracket 30, and the motor module 14 comprises an upwards rotatable part 10b enabling adapting the motor module 14 to fit inside open cross section between the fixing bracket and the wall of the hoistway.

One option is to move the machinery 13 with roping 21 and the motor bed 10 separately through the fixing bracket 30 to the next jump floor.

It will be obvious to a person skilled in the art that, as the technology advances, the inventive concept can be implemented in various ways. The invention and its embodiments are not limited to the examples described above but may vary within the scope of the claims.

1. A method for installing an elevator during construction of a building comprising
providing an elevator car, a counterweight, car guide rails for guiding the car, counterweight guide rails for guiding the counterweight, an elevator hoisting machinery and a suspension roping for suspending the car and the counterweight during construction time use of the elevator,
providing a first rope terminal and a second rope terminal for supporting the suspension roping,
mounting a car guide rail and two counterweight guide rails on fixing brackets,
mounting the counterweight vertically movably on the opposite counterweight guide rails inside said fixing brackets, between said fixing brackets and a wall of a hoistway,
providing a motor module comprising a motor bed, the elevator hoisting machinery mounted on the motor bed,
vertically moving the car during construction time use by the elevator hoisting machinery suspending the car and the counterweight together with the suspension roping,
connecting the guide rails below and above the motor bed to each other through the motor bed,
in connection with an elevator jump, hoisting the motor module guided by the counterweight guide rails through one or more fixing brackets to a desired height in the hoistway, and
fixing the motor module on said guide rails.

2. The method according to claim 1, wherein before the jump, lowering the counterweight to the bottom of the hoistway to a suitable height and slackening ropes or belts of the suspension roping;
and preferably
pulling the belts or ropes to the counterweight side of the car and taking them off a drive wheel of the elevator hoisting machinery.

3. The method according to claim 1, wherein guiding the motor module comprising guiding and fixing elements, such as guide shoes or guide rollers, in a controlled manner along the counterweight guide rails when hoisted.

4. The method according to claim 1, wherein moving the motor module comprising horizontal displacement means enabling horizontal movement of the motor bed relative to the fixing bracket and adapting the motor module inside an open cross section between the fixing bracket and a wall of the hoistway.

5. The method according to claim 1, wherein rotating an upwards rotatable front part comprised by the motor module and adapting the motor module to fit inside open cross section between the fixing bracket and a wall of the hoistway.

6. The method according to claim 1, wherein hoisting the motor module upwards by a material hoist or equivalent hoisting device operating from upward direction.

7. The method according to claim 1, wherein opening an automatic rope lock comprised by the second rope terminal to allow more belt or rope to be transferred into the roping system.

8. The method according to claim 1, wherein before hoisting the car, detaching the first rope terminal on the opposite side of the counterweight from the car guide rail and attaching it to the car.

9. The method according to claim 1, wherein performing the upward hoisting by hoisting the motor module to which the second rope terminal is attached at the same time.

10. The method according to claim 1, wherein the hoisting roping comprises plurality of ropes, which are preferably PU-coated.

11. The method according to claim 1, wherein after finishing the final height of the hoistway, the motor bed is fixed on top of the guide rails.

12. The method according to claim 1, wherein mounting at least one protection deck within the hoistway having a bottom section, a top section and an optional at least one intermediate section between the bottom and top sections in the building, for an elevator section installation,
providing an installation platform to be guided on car guide rails during installation of at least one hoistway section,
providing a hoist device,
guiding a working platform on car guide rails and the counterweight on counterweight guide rails installed at the bottom of the hoistway,
attaching to the working platform the hoist device comprising a man riding hoist and a hoist rope,
providing a hoisting point to support the working platform via the hoist device and the hoist rope,
mounting the hoisting point to the protection deck for the bottom section elevator installation, and installing elevator components in the bottom section using the working platform as an installation platform,
after each section elevator installation,
during construction time use of the car, using the installation platform as installation platform for an above section installation;
and preferably
moving the car during construction time use
after the hoisting point and the hoist device are removed from the bottom section, or
after the hoisting point, the hoist device and the installation platform are removed from the installed hoistway section.

13. The method according to claim 12, comprising installing the elevator hoisting machinery, supported by the car guide rail at a top of the bottom section, and installing the suspension roping to suspend the car and the counterweight, and moving the car during construction time use in the bottom section, after the hoist device, or after the hoist device and the installation platform, is removed from the bottom section.

14. The method according to claim 12, comprising, during the elevator installation in the at least one intermediate section, mounting the hoisting point to an upper protection deck, attaching to the installation platform the hoist device and the hoist rope, and using the installation platform as installation platform;
and preferably,
after the intermediate section installation, installing the elevator hoisting machinery, supported by the car guide rail at a top of the intermediate section, and installing an extended suspension roping to suspend the car and the counterweight, and moving the car during construction time use in the intermediate section, after the hoist device and the installation platform are removed from the intermediate section.

15. The method according to claim 13, comprising hoisting the motor module by a material hoist supported by the protection deck.
